(19) United States
(12) Patent Application Publication
(10) Pub. No.: US 2024/0254575 A1
(43) Pub. Date: Aug. 1, 2024

(54) A method for manufacturing direct reduced iron

(71) Applicant: ArcelorMittal, LUXEMBOURG (LU)

(72) Inventors: Sarah SALAME, Maizieres les Metz (FR); Odile CARRIER, Metz (FR); Jose BARROS LORENZO, Maizieres les Metz (FR); Jon REYES RODRIGUEZ, AVILES Asturias (ES); Marcelo ANDRADE, East Chicago, IN (US); Dmitri BOULANOV, East Chicago, IN (US); Dennis LU, East Chicago, IN (US); George TSVIK, Valparaiso, IN (US)

(21) Appl. No.: 18/290,551

(22) PCT Filed: May 19, 2022
(86) PCT No.: PCT/IB2022/054679

§ 371 Date: Nov. 14, 2023

(30) Foreign Application Priority Data
May 31, 2021 (WO) PCT/IB2021/054751

(51) Int. Cl. C21B 13/00; C21B 13/02

(52) U.S. Cl. CPC C21B 13/008; C21B 13/0073; C21B 13/02; C21B 2100/22; C21B 2100/26; C21B 2100/282

(57) ABSTRACT

A method for manufacturing direct reduced iron wherein iron ore is reduced in a direct reduction furnace by a reducing gas, the reducing gas exiting the furnace through the top as a top reduction gas. The top reduction gas is captured and at least partly subjected to a CO2 recovery step during which it is divided into two streams, a CO2-rich stream and a CO2-poor stream. The CO2-rich stream is subjected to an alkanol production step to produce an alkanol product.

### BACKGROUND

Steel can be currently produced through two mains manufacturing routes. Nowadays, the most commonly used production route consists in producing pig iron in a blast furnace, by use of a reducing agent, mainly coke, to reduce iron oxides. In this method, approx. 450 to 600 kg of coke is consumed per metric ton of pig iron; this method, both in the production of coke from coal in a coking plant and in the production of the pig iron, releases very significant quantities of CO2. Produced pig iron is then decarburized, for example in a converter or Basic Oxygen Furnace (BOF) to produce steel which is then refined to get the appropriate composition. This is called the BF-BOF route.

The second main route involves so-called “direct reduction methods”. Among them are methods according to the brands MIDREX, FINMET, ENERGIRON/HYL, COREX, FINEX etc., in which sponge iron is produced in the form of HDRI (hot direct reduced iron), CDRI (cold direct reduced iron), or HBI (hot briquetted iron) from the direct reduction of iron oxide carriers. Sponge iron in the form of HDRI, CDRI, and HBI usually undergo further processing in electric arc furnaces.

There are 3 zones in each direct reduction shaft with cold DRI discharge: Reduction zone at top, transition/intermediate zone at the middle, cooling zone at the cone shape bottom. In hot discharge DRI, this bottom part is used mainly for product homogenization before discharge, and control of overall solids follow.

Reduction of the iron oxides occurs in the upper section of the furnace, at temperatures up to 950° C. Iron oxide ores and pellets containing around 30% by weight of Oxygen are charged to the top of a direct reduction shaft and are allowed to descend, by gravity, through a reducing gas. This reducing gas is entering the furnace from the bottom of reduction zone and flows counter-current from the charged oxidized iron. Oxygen contained in ores and pellets is removed in stepwise reduction of iron oxides in counter-current reaction between gases and oxide. Oxidant content of gas is increasing while gas is moving to the top of the furnace.

The reducing gas generally comprises hydrogen and carbon monoxide (syngas) and is obtained by the catalytic reforming of natural gas. For example, in the so-called MIDREX method, first methane is transformed into a reformer according to the following reaction to produce the syngas or reduction gas:

$$CH4 + CO2 = 2 C O + 2 H2$$

and the iron oxide reacts with the reduction gas, for example according to the following reactions:

$$3 Fe203 + CO / H2 -> 2 Fe304 + CO2 / H2O$$

$$Fe304 + CO / H2 -> 3 FeO + CO2 / H2O$$

$$FeO + CO / H2 -> Fe + CO2 / H2O$$

At the end of the reduction zone the ore is metallized.

A transition section is found below the reduction section; this section is of sufficient length to separate the reduction section from the cooling section, allowing an independent control of both sections. In this section carburization of the metallized product happens. Carburization is the process of increasing the carbon content of the metallized product inside the reduction furnace through following reactions:

$$3 Fe + C H 4 \to F e 3 C + 2 H2$$

$$3 Fe + 2 CO \to Fe3C + CO2$$

$$3 Fe + C O + H 2 \to F e 3 C + H2O$$

Injection of natural gas in the transition zone is using sensible heat of the metallized product in the transition zone to promote hydrocarbon cracking and carbon deposition. Due to relatively low concentration of oxidants, transition zone natural gas is more likely to crack to H2 and Carbon than reforming to H2 and CO. Hydrocarbon cracking provides carbon for DRI carburization and, at the same time adds reductant (H2) to the gas that increases the gas reducing potential.

Gas injection is also performed into cooling zone, it usually consists in recirculating cooling gas plus added natural gas. Natural gas (NG) addition to cooling gas allows operator to keep the recirculating cooling gas circuit with a high content in methane, otherwise, the predominant component in the cooling gas would be Nitrogen. The heat capacity of natural gas is much more than N2: cooling gas recirculating flow is 500-600 Nm3/t with NG, and 800 Nm3/t without NG. Although there will not be too much carbon deposition in cooling zone, but the up flow of cooling gas to higher levels of the furnace will provide more hydrocarbon for cracking.

As can be seen from above reactions, even if the direct reduction route has a lower CO2 footprint than the BF-BOF route, the direct reduction process is still a CO2 producer.

### SUMMARY OF THE INVENTION

There is a need for a method allowing to further reduce carbon emissions.

There is also a need for a method allowing to increase carbon content in the DRI product without necessity of an external carbon source. Content of carbon in the DRI product is a key parameter at it plays an important role into the subsequent steps but it also helps to improve the transportability of the DRI product.

The present invention also provides a method, wherein iron ore is reduced in a direct reduction furnace by a reducing gas, the reducing gas exits the furnace through the top as a top reduction gas, this top reduction gas is captured and at least partly subjected to a CO2 recovery step during which it is divided into two streams, a CO2-rich stream and a CO2-poor stream, the CO2-rich stream being subjected to an alkanol production step to produce an alkanol product.

The method of the invention may also comprise the following optional characteristics considered separately or according to all possible technical combinations:
the alkanol product is then at least partly injected into the direct reduction furnace,
the CO2-poor stream is re-injected into the furnace as reducing gas,
the CO2-rich stream contains between 80 and 100% in volume of carbon dioxide,
from 1 to 20% in volume of the top reduction gas is subjected to the alkanol production step,
a hydrogen stream is supplied to the alkanol production step to react with the CO2-rich stream,
the produced alkanol product is a gas which is mixed with the reduction gas before its injection into the furnace,
the produced alkanol is a liquid,
the produced alkanol is injected separately from the reducing gas, in the transition zone of the furnace,
the produced alkanol is injected in the cooling zone of the furnace,
the alkanol chain includes from 1 to 5 carbons,
the alkanol product is methanol,
the alkanol product is ethanol,
prior to its injection into the direct reduction furnace, the reducing gas is heated in a reducing gas preparation step, said reducing gas preparation step emitting a preparation exhaust gas which is at least partly supplied to the alkanol production step.

The invention is also related to a direct reduction plant to perform a method according to the invention comprising an alkanol production unit.

### BRIEF DESCRIPTION OF THE DRAWINGS

Other characteristics and advantages of the invention will emerge clearly from the description of it that is given below by way of an indication and which is in no way restrictive, with reference to the appended figures in which:

FIG. 1 illustrates a layout of a direct reduction plant allowing to perform a method according to the invention

FIGS. 2A and 2B are curves simulating the increase of the carbon content into the DRI product when injecting liquid Ethanol or Methanol

### DETAILED DESCRIPTION

Elements in the figures are illustration and may not have been drawn to scale.

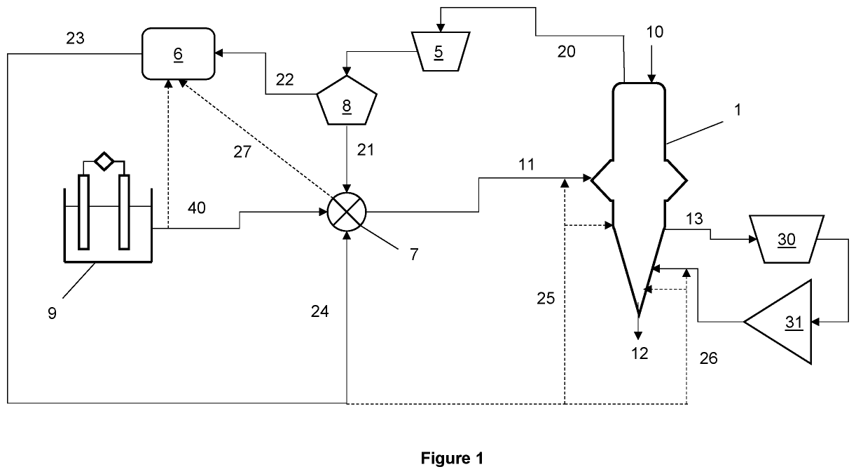

FIG. 1 illustrates a layout of a direct reduction plant allowing to perform a method according to the invention. The direct reduction furnace (or shaft) 1 is charged at its top with oxidized iron 10 in form of ore or pellets. Said iron 10 is reduced into the furnace 1 by a reducing gas 11 injected into the furnace and flowing counter-current from oxidized iron. Reduced iron 12 exits the bottom of the furnace 1 for further processing, such as briquetting before being used in subsequent steelmaking steps. Reducing gas after having reduced iron exits at the top of the furnace as a top reduction gas 20 (TRG).

The top reduction gas 20 usually comprises from 15 to 25% v of CO, from 12 to 20% v of CO2, from 35 to 55% of H2, from 15 to 25% v of H2O, from 1 to 4% of N2. It has a temperature from 250 to 500° C.

A cooling gas 13 is captured out of the cooling zone of the furnace, subjected to a cleaning step into a cleaning device 30, such as a scrubber, compressed in a compressor 31 and then sent back to the cooling zone of the shaft 1.

According to the invention, the top reduction gas 20, preferentially after a dust and mist removal step in a cleaning device 5, such as a scrubber and a demister, is sent to a CO2 recovery device 8 where CO2 from the top reduction gas is concentrated and divided into a CO2-poor stream 21 and a CO2-rich stream 22. The first stream 21, being poor in CO2, is sent to a preparation device 7 where it will be mixed with other gas, optionally reformed and heated to produce the reducing gas 11. In a preferred embodiment, the preparation device 7 is a reformer. The preparation device 7 emits a preparation exhaust gas 27, also called stack gas.

The CO2 recovery device may be an absorption device, an adsorption device, a cryogenic distillation device or membranes. It could also be a combination of those different devices.

The second stream 22, which is rich in CO2 and representing preferably from 1 to 20% v of the top reduction gas 20, is sent to an alkanol production device 6 to be subjected to an alkanol production step. This second stream may comprise between 80 and 100% v of CO2. In the alkanol production device 6, CO2 may be first transformed into carbon monoxide CO. This may be done for example through a hydrogenation step, when hydrogen is available in sufficient amount, to produce CO according to the following reaction:

$$C02 + H2 -> CO + H2O$$

This reaction is the so-called Reverse Water Gas Shift reaction (RGWS). This reaction is performed in presence of a catalyst such as ZnAl2O4 or Fe₂O3/Cr2O3. It may also be done by a thermochemical transformation such as Boudouard Reaction or methane reforming, by an electrochemical transformation or with a plasma technology.

CO thus produced is then transformed into alkanols according to Fischer-Tropsch reactions:

$$2 {n H}_{2} + n CO -- > {C}_{n} {H}_{2 n + 1} OH + ( n - 1 ) {H}_{2} O$$

Wherein n is an integer superior or equal to 1 and is preferentially from 1 to 5. The man skilled in the art know how to choose the right catalyst and/or process conditions to perform the wanted Fischer-Tropsch reaction and produce the targeted hydrocarbon.

Transformation of CO2 into alkanol may be done in a two-step process as described but it can also be done by a direct synthesis, i.e in a single step. In a preferred embodiment, it is a fermentation process.

In a preferred embodiment CO2 and H2 contained into the CO2-rich stream 22 react to form methanol CH3OH according to the following reaction:

$$CO 2 + 4 H2 -- > CH3OH + 2 H2O$$

In this embodiment the alkanol production device is a methanol production device 6 such as catalytic reactors or bioreactors.

In case the content of H2 into the top reduction gas and thus in the second stream 22 would not be enough for the alkanol production reaction, additional H2 stream 40 may be supplied to the alkanol production unit 6. This H2 stream may be provided by a dedicated H2 production plant 9, such as an electrolysis plant. It may be a water or steam electrolysis plant. It is preferably operated using CO2 neutral electricity which includes notably electricity from renewable source which is defined as energy that is collected from renewable resources, which are naturally replenished on a human timescale, including sources like sunlight, wind, rain, tides, waves, and geothermal heat. In some embodiments, the use of electricity coming from nuclear sources can be used as it is not emitting CO2 to be produced.

This H2 stream 40 may also be added to the reducing gas 11.

The stack gas 27 may also be supplied to the alkanol production unit 6.

In a preferred embodiment, the alkanol product 23 exiting the hydrocarbon production device 6 is reinjected into the furnace 1.

In a first embodiment, illustrated by stream 24, this alkanol product 23 is a gas which is mixed with the reducing gas in the preparation device.

In a second embodiment, illustrated by stream 25, it is either injected into the furnace together with the reducing gas or injected independently in the transition zone of the furnace. In a third embodiment, illustrated by stream 26, it is either injected into the furnace together with the cooling gas 13 or injected independently in the cooling zone of the furnace. The alkanol product 23 may be in a gaseous and/or in a liquid form. All those embodiments may be combined with one another.

In all embodiments, the alkanol product serves as a carbon supplier for the DRI product. In a preferred embodiment, carbon content of the Direct Reduced Iron is set from 0.5 to 3 wt. %, preferably from 1 to 2 wt. % which allows getting a Direct Reduced Iron that can be easily handled and that keeps a good combustion potential for its future use. The amount of gas sent to the alkanol production device may be controlled according to the amount of carbon needed in the DRI product.

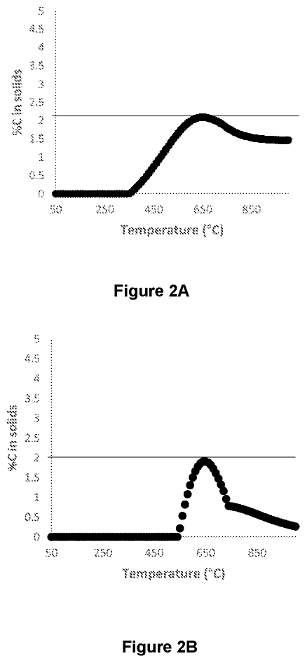

FIGS. 2A and 2B are curves simulating the evolution of the percentage in weight of carbon into the direct reduced iron product versus temperature when injecting respectively 100 kg/ton of DRI of liquid Ethanol (FIG. 2A) or 430 kg/ton of DRI of liquid Methanol (FIG. 2B). In both cases we can see that when the liquid is injected into the transition zone and/or cooling zone of the furnace, it is possible to reach a carbon content in the solid product of around 2% in weight. The advantage of ethanol is that a smaller quantity is needed compared to methanol and it is more available. The simulation was performed using thermodynamical models.

The method according to the invention allows to reduce the carbon footprint of the direct reduction process by capture and use of the emitted CO2. It may also avoid the need of an external source to increase the carbon content into the DRI product.

1-15. (canceled)

16. A method for manufacturing direct reduced iron, the method comprising:
reducing iron ore in a direct reduction furnace by a reducing gas, the reducing gas exiting the furnace through a top as a top reduction gas;
capturing the top reduction gas;
at least partly subjecting the top reduction gas to a CO2 recovery step, the top reduction gas during the CO2 recovery step being divided into a CO2-rich stream and a CO2-poor stream; and
subjecting the CO2-rich stream to an alkanol production step to produce an alkanol product.

17. The method as recited in claim 16 wherein the alkanol product is then at least partly injected into the direct reduction furnace.

18. The method as recited in claim 16 wherein the CO2-poor stream is re-injected into the furnace as at least part of the reducing gas.

19. The method as recited in claim 16 wherein the CO2-rich stream contains between 80 and 100% in volume of carbon dioxide.

20. The method as recited in claim 16 wherein from 1 to 20% in volume of said top reduction gas is subjected to the alkanol production step.

21. The method as recited in claim 16 wherein a hydrogen stream is supplied to the alkanol production step to react with the CO2-rich stream.

22. The method as recited in claim 16 wherein the alkanol product is a gas mixed with the reducing gas before injection into the furnace.

23. The method as recited in claim 16 wherein the alkanol product is a liquid.

24. The method as recited in claim 16 wherein the alkanol product is injected separately from the reducing gas, in a transition zone of the furnace.

25. The method as recited in claim 16 wherein the alkanol product is injected in a cooling zone of the furnace.

26. The method as recited in claim 16 wherein the alkanol product is an alkanol having a chain of 1 to 5 carbons.

27. The method as recited in claim 26 wherein the alkanol product is methanol.

28. The method as recited in claim 26 wherein the alkanol product is ethanol.

29. The method as recited in claim 16 wherein, prior to injection into the direct reduction furnace, the reducing gas is heated in a reducing gas preparation step, the reducing gas preparation step emitting a preparation exhaust gas which is at least partly supplied to the alkanol production step.

30. A direct reduction plant performing the method as recited in claim 16 wherein, the direct reduction plant comprising an alkanol production unit.
